(19) United States
(12) Patent Application Publication
(10) Pub. No.: US 2025/0116969 A1
(43) Pub. Date: Apr. 10, 2025

(54) CERAMIC PART WITH A COLOUR GRADIENT AND ITS MANUFACTURING METHOD

(71) Applicant: Omega SA, Biel/Bienne (CH)

(72) Inventors: Alexandre NETUSCHILL, Diesse (CH); Sébastien RETROUVEY, Chissey sur Loue (FR); Arnaud ACTIS-DATTA, Bassecourt (CH); Pierry VUILLE, Les Emibois (CH); Nicolas OIAN, Grimisuat (CH); Gregory KISSLING, La Neuveville (CH)

(73) Assignee: Omega SA, Biel/Bienne (CH)

(21) Appl. No.: 18/894,104

(22) Filed: Sep. 24, 2024

(30) Foreign Application Priority Data
Oct. 10, 2023 (EP) 23202755.7

(51) Int. Cl. G04B 45/00; B28B 3/02; B28B 7/00; G04B 19/28

(52) U.S. Cl. CPC G04B 45/0076; B28B 3/02; B28B 7/0002; G04B 19/283

(57) ABSTRACT

A ceramic part with a colour gradient, and in particular to a bezel of a timepiece, made using a method involving the injection of at least two differently-coloured ceramic materials, the ceramic materials being mixed in different weight ratios to create a plurality of mixed materials forming a colour gradient.

### TECHNICAL FIELD

The present invention relates to a ceramic part. It relates more particularly to a watch component such as a bezel, made by uniaxial pressing of differently-coloured ceramic materials forming a colour progression to decorate the watch component.

### PRIOR ART

Ceramic or cermet watch components are generally obtained by a method involving the injection of a material followed by sintering. These components often feature decoration, such as indexes and numerals on a bezel, in a colour that is different from the rest of the component. The decorative elements are generally brazed or glued onto the sintered blank part This mechanical assembly between the blank part and the decorative elements can be costly and complicated to implement.

An alternative to this mechanical assembly is to produce an blank part by injecting differently-coloured materials with a colour intended to form the decoration after machining. However, manufacturing ceramic or cermet components in different colours is a complex process. In fact, significant shrinkage, up to 30%, is observed during sintering. The shrinkage rate will depend on several factors, including the choice of material and the volume of material injected. In bi-injection or, more generally, multi-injection methods, shrinkage differences can appear during sintering, leading to separation at the junction between the various materials or to pigment diffusion from one colour to another.

To remedy this drawback, document EP 2 746 243 proposes forming a green body and impregnating part of this green body before sintering with a solution comprising a metal acting as a pigment. However, the drawback to this method is that it is difficult to obtain a uniform colour throughout the coloured part.

Document EP 2 965 713 also describes a method for obtaining a ceramic material with a colour progression and forming a dental prosthesis. However, such a method uses isostatic pressing, which is generally time-consuming and demanding. Moreover, such a method cannot be applied industrially for mass production.

### SUMMARY OF THE INVENTION

The present invention aims to remedy the aforementioned drawbacks by providing a new uniaxial pressing method for obtaining a ceramic part with a colour gradient.

To this end, the present invention relates to a method for manufacturing a ceramic part with a colour gradient.

More specifically, the method for manufacturing the part by uniaxial pressing according to the invention comprises the following steps:
preparing at least a first ceramic material and a second ceramic material, the first ceramic material differing in colour from the second ceramic material;
preparing a press tool with an impression;
placing a grid in the impression to form compartments in the impression;
preparing a plurality of mixed materials in which the first ceramic material and the second ceramic material are mixed in different weight ratios while varying the weight ratio to form a desired colour progression;
depositing the materials in the compartments in ascending or descending order according to the weight ratio;
removing the grid and uniaxially pressing the materials to form a green body;
debinding the green body to obtain a brown body;
sintering the brown body to form a blank part;
finishing the blank part to obtain the part.

The present invention also relates to the ceramic part resulting from the manufacturing method.

According to other advantageous variants of the invention:
the first ceramic material and the second ceramic material comprise either: a zirconium oxide powder, an aluminium oxide powder, a titanium nitride powder, a silicon nitride powder, a titanium carbide powder, a chromium carbide powder, a tungsten carbide powder or a mixture of at least two of these powders;
the first ceramic material and the second ceramic material each comprise a different pigment giving a different colour to the first ceramic material and to the second ceramic material;
the pigment is a metal oxide or a spinel;
the pigment is chosen among a chromium oxide, a cobalt oxide, an iron oxide, a titanium oxide, a manganese oxide, a molybdenum oxide, a cerium oxide, a vanadium oxide, a zinc oxide, an aluminium oxide or a mixture of these oxides;
the pigment is a cobalt/iron/chromium spinel or a cobalt/aluminium spinel;
the first ceramic powder and the second ceramic powder each comprise a binder;
the sintering step is carried out at a temperature comprised between 1,200° C. and 1,800°° C. for a time comprised between 30 minutes and 20 hours;
the sintering step is carried out in an oxidising or reducing environment.

The invention also relates to a ceramic part with a colour gradient.

The part according to the invention comprises several different ceramic materials that vary in colour and, more generally, in aesthetic appearance. According to the invention, the decorated part is in one piece and with no discontinuity between the ceramic materials of the part so as to obtain a colour gradient.

Other features and advantages of the present invention will become apparent in the following description of a preferred embodiment, presented by way of non-limiting example with reference to the appended drawings.

### BRIEF DESCRIPTION OF THE FIGURES

FIGS. 1a to 1c illustrate exemplary embodiments of ceramic parts with a colour progression obtained using the manufacturing method according to the invention.

FIG. 2 shows a plan view of an blank part with the grid used to form a bezel using the manufacturing method according to the invention.

FIGS. 3a to 3e illustrate the various steps in the manufacturing method according to the invention.

### DETAILED DESCRIPTION

The present invention relates to a ceramic part such as an external part used in horology or in jewelry, or even a watch component with a colour gradient throughout its entire mass. “Colour gradient” refers to a colour progression with at least two colours used as the basis for creating the progression. Of course, the colour progression can have more than two base colours.

The component according to the invention is made of ceramic. For example, it can be zirconium oxide, aluminium oxide, titanium nitride, silicon nitride or even a carbide such as titanium carbide, chromium carbide or tungsten carbide, or even a mixture of these ceramics.

“Ceramic material” refers to any type of material known to the person skilled in the art for making ceramic parts, such as powder or granulates, for example.

At least one of the ceramic materials comprises a pigment that colours the material. The pigment is a metal oxide or a spinel chosen according to the desired colour. Examples include chromium oxide, cobalt oxide, iron oxide, titanium oxide, manganese oxide, zinc oxide, molybdenum oxide, cerium oxide, vanadium oxide, aluminium oxide or a mixture of these oxides such as an iron/chromium oxide, for example. For example, for a blue colour the pigment can be a cobalt oxide, for a green colour the pigment can be a chromium oxide, for a brown colour the pigment can be an iron oxide.

The part according to the invention can also be a decorative part such as a constituent component for watches, jewels, wristlets, etc. In the field of horology, this part can be an external part such as a middle, a back, a bezel, a bezel insert, a button, a crown, a wristlet link, a clasp, a buckle, a dial, a hand, a dial index, etc. It can also be a component of the movement such as an oscillating weight, a platinum, etc. By way of illustration, the part is a bezel 1 made with differently-coloured ceramics, for example with a gradient ranging from black to turquoise blue. As a further example, it could be an acronym on a watch crown or even an index on a bezel.

The part is made by means of uniaxial pressing of the various ceramic materials to form a green body. The manufacturing method is illustrated below for a part comprising seven successive differently-coloured materials, but it could be a part comprising 2, 3, 4, etc. materials with different colours, different compositions or even different pigment concentrations.

The method for manufacturing by uniaxial pressing includes the following steps with reference to the figures:
preparing at least a first ceramic powder 2 and a second ceramic powder 3, the first differing from the second by its colour and therefore by its chemical composition;
preparing an impression 5;
placing a grid 6 in the impression 5 to form compartments 4 in the impression, the compartments optionally having various and varied forms. In the illustrated case of the bezel, the compartments can be in the form of sectors, vertical strips or vertical lines. Of course, any other geometry is possible, such as a wave form, for example. The grid is at least 4 mm high, and the number of compartments formed depends on the desired final decoration;
preparing a plurality of mixed materials 20, 21, 22, 23, 24 in which the first ceramic material 2 and the second ceramic material 3 are mixed in different weight ratios while varying the weight ratio from 0 to 100% to form a desired colour progression. Thus, when two ceramic materials are used, the mixed materials can have a weight ratio of 100/0, 90/10, 80/20, 70/30, 60/40, 50/50, 40/60, 30/70, 20/80, 10/90, 0/100, etc. A person skilled in the art will have no difficulty using more than two ceramic materials, for example three, four or five ceramic materials, to obtain the desired colours and the desired colour gradient;
depositing the mixed materials 20, 21, 22, 23, 24 in the compartments 4 in ascending or descending order according to the desired weight ratio or gradient. The height of the mixed materials deposited in the compartments is at least 0.5 mm and does not exceed the height of the grid;
removing the grid 6 and uniaxially pressing the mixed materials to form a green body 7. This is a particularly useful step in terms of achieving good colour homogeneity throughout the part. In fact, when the grid 6 is removed, the space left by the grid causes the mixed materials to settle slightly;
thermally debinding the green body 7 to obtain a brown body;
sintering the brown body to form an blank part;
finishing the blank part to form the part 1.

Several layers of mixed ceramic materials or powders can be stacked to form a particular colour pattern visible from the sides of the part.

An example with two powders is given, but a person skilled in the art will not find it particularly difficult to prepare.

The ceramic material used is predominantly ceramic powder.

The green body is thermally debinded in a temperature range comprised between 100 and 800° C. This step makes it possible to obtain a brown body.

The brown body is sintered in a temperature range comprised between 1,200 and 1,800° C., and preferably between 1,350 and 1,450° C., for a time comprised between 30 minutes and 20 hours. The person skilled in the art knows that each colour has an optimum temperature and an optimum sintering time during sintering so that the colour comes out right after sintering. Thus, when creating a progression, it is particularly useful to choose colours with similar sintering temperatures and times and to sinter at a temperature that is the average of the ideal sintering temperatures of the chosen colours.

Preferably, the temperature is increased to the required sintering temperature at a rate of 100°° C. to 200°° C. per hour. Once sintering is complete, the temperature is gradually lowered at a rate of 100° C. to 200° C. per hour.

The brown body is sintered in an oxidising or reducing environment depending on the pigment used and the desired colour. For example, sintering can be carried out in an oxygenated atmosphere, which can be ordinary air or an atmosphere created artificially by combining oxygen and other gases. For the sake of simplicity and cost-effectiveness, ordinary air is preferred. The oxygenated atmosphere may be static or there may be a constant or intermittent flow of gas.

Depending on the needs of the person skilled in the art, several sintering steps can be carried out to achieve the desired result.

To form a bezel, the blank part is machined to the dimensions of the desired part.

The method can comprise laser ablation machining to form decorations in the part. The decorations can consist of indexes, a graduation or a logo, for example.

After laser ablation machining, the manufacturing method includes a finishing step such as polishing, satin-finishing, mattifying, etc. Post-sintering machining also helps make the colour progression or a particular pattern stand out more clearly, depending on the section of the part.

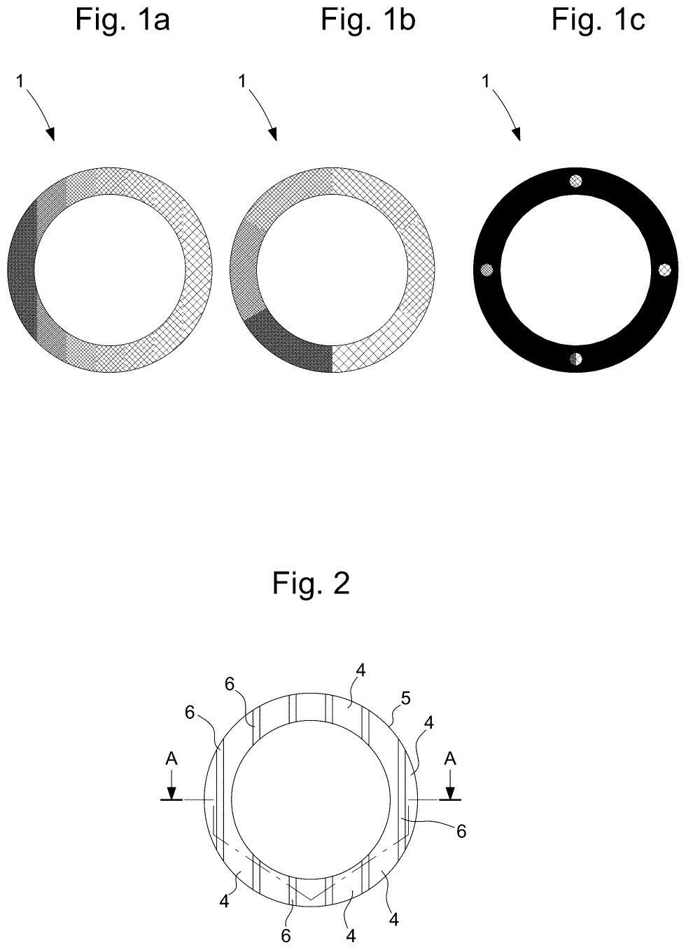

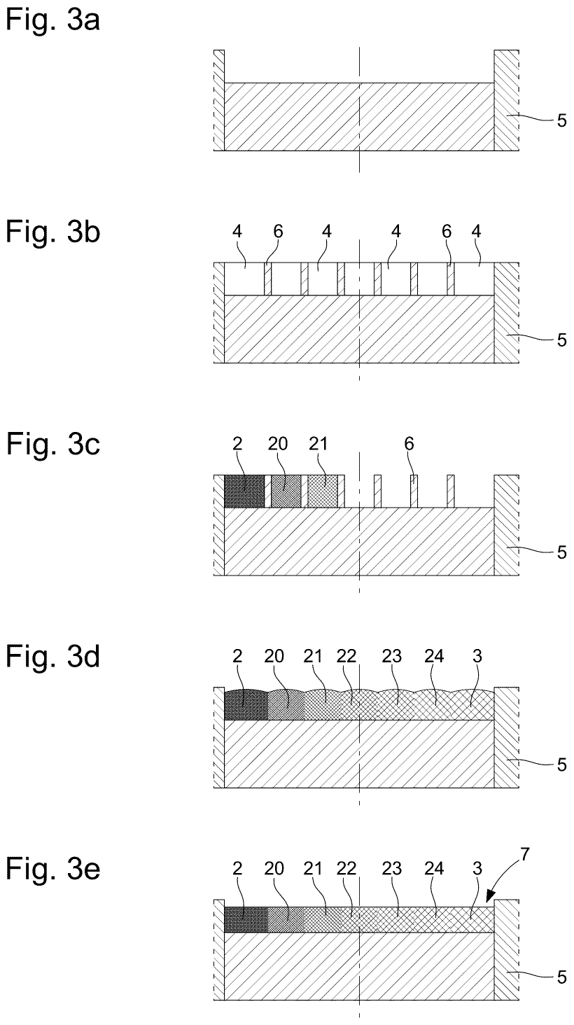

Typically, a bezel 1 according to FIGS. 1a to 1c is obtained using the method according to the invention, the bezel having a colour gradient ranging from black to turquoise blue. Of course, other gradients based on other colours can be obtained using this method.

1. A method for manufacturing a ceramic part with a colour gradient by uniaxial pressing, said method comprising the following steps:
preparing at least a first ceramic material and a second ceramic material, the first ceramic material differing in colour from the second ceramic material;
preparing an impression;
placing a grid in the impression to form compartments in the impression;
preparing a plurality of mixed materials wherein the first ceramic material and the second ceramic material are mixed in different weight ratios while varying the weight ratio to form a desired colour gradient;
depositing the materials in the compartments in ascending or descending order according to the weight ratio;
removing the grid and uniaxially pressing the materials to form a green body;
debinding the green body to form a brown body;
sintering the brown body to form an blank part;
machining the resulting blank part to obtain the part.

2. The manufacturing method according to claim 1, wherein the first ceramic material and the second ceramic material comprise either: a zirconium oxide powder, an aluminium oxide powder, a titanium nitride powder, a silicon nitride powder, a titanium carbide powder, a chromium carbide powder, a tungsten carbide powder or a mixture of at least two of these powders.

3. The manufacturing method according to claim 1, wherein the first ceramic material and the second ceramic material each comprise a different pigment giving a different colour to the first ceramic material and to the second ceramic material.

4. The method according to claim 1, wherein the pigment is a metal oxide or a spinel.

5. The method according to claim 4, wherein the pigment is chosen among a chromium oxide, a cobalt oxide, an iron oxide, a titanium oxide, a manganese oxide, a molybdenum oxide, a cerium oxide, a vanadium oxide, a zinc oxide, an aluminium oxide or a mixture of these oxides.

6. The method according to claim 4, wherein the pigment is a cobalt/iron/chromium spinel or a cobalt/aluminium spinel.

7. The method according to claim 1, wherein the first ceramic powder and the second ceramic powder each comprise a binder, the binder being present between X and Y % by weight.

8. The method according to claim 1, wherein the sintering step is carried out at a temperature comprised between 1,200° C. and 1,800° C. for a time comprised between 15 minutes and 20 hours.

9. The method according to claim 1, wherein the sintering step is carried out in an oxidising or reducing environment.

10. A ceramic part comprising a colour gradient.

11. The part according to claim 10, wherein the part is a watch component used for the external parts or in the movement.

12. The part according to claim 10, wherein the watch component used for the external parts or in the movement is chosen from the list comprising a middle, a back, a bezel, a bezel insert, a button, a crown, a wristlet link, a buckle, a dial, a hand, a bar, a rack, a dial index, an oscillating weight and a platinum.
